(19) United States
(12) Patent Application Publication
(10) Pub. No.: US 2015/0061655 A1
(43) Pub. Date: Mar. 5, 2015

(54) MAGNETIC SENSING DEVICE USING MAGNETISM TO DETECT POSITION

(71) Applicant: FANUC CORPORATION, Yamanashi (JP)

(72) Inventor: Hirosato Yoshida, Yamanashi (JP)

(21) Appl. No.: 14/469,998

(22) Filed: Aug. 27, 2014

(30) Foreign Application Priority Data
Aug. 28, 2013 (JP) 2013-176997

(51) Int. Cl. G01D 5/16

(52) U.S. Cl. CPC G01D 5/16
USPC 324/207.21

(57) ABSTRACT

A position signal generating part 11 has a series of a plurality of continuous projections and indentations provided with a pitch λ in the direction of the circumference of a rotating body 10. An origin signal generating part 12 has a discontinuous portion 12b that partly interrupts the continuity of the series of the plurality of projections and indentations provided with the pitch λ in the direction of the circumference of the rotating body 10. A third magnetoresistive element 23 and a fourth magnetoresistive element 24 are spaced from each other in the direction of the circumference of the rotating body 10 with a distance equal to the pitch multiplied by m (m=1, 2, 3, . . . ) for detecting a change in a magnetic field that corresponds to an origin signal.

### CROSS-REFERENCE TO RELATED APPLICATIONS

This application is a new U.S. patent application that claims benefit of JP 2013-176997, filed on Aug. 28, 2013, the entire content of JP 2013-176997 is hereby incorporated by reference.

### FIELD OF THE INVENTION

The present invention relates to a magnetic sensing device including a movable body made of a magnetic material and a sensor using magnetism to detect a position of the movable body.

### BACKGROUND OF THE INVENTION

Examples of magnetic sensing devices that use magnetism to detect a position include magnetic encoders, etc., that detect a rotation angle as a rotational position of a rotating member such as the output shaft of a motor or a rotary shaft driven by a motor.

Conventionally, magnetic sensing devices have been proposed that have a rotating body including a position signal generating part in which a plurality of continuous projections and indentations are provided with a predetermined pitch in the direction of the circumference of the rotating body for generating a position signal representing a position of the rotating body of the magnetic sensing device and a magnetic-field signal generating part which is integral with the position signal generating part and in which a plurality of continuous projections and indentations are formed with the pitch in the direction of the circumference and a groove having a length in the direction of the circumference that is equal to the pitch is formed for generating a signal corresponding to a change in a magnetic field (For example, Japanese Unexamined Patent Publication No. JP-A-11-153451, Japanese Patent Publication No. JP-4240306, and Japanese Unexamined Patent Publication No. JP-A-2011-154007).

In this case, the sensor of the magnetic sensing devices includes a pair of magnetoresistive elements spaced from each other in the direction of the circumference with a distance equal to the pitch multiplied by ½ in order to detect a change in a magnetic field corresponding to a position signal and another pair of magnetoresistive elements spaced from each other in the direction of the circumference with a distance equal to the pitch multiplied by ½ in order to detect a change in a magnetic field corresponding to a magnetic-field signal. These pairs of magnetoresistive elements output a position signal and a magnetic-field signal to a circuit connected to the magnetic sensing device. The circuit connected to the magnetic sensing device includes a subtracter or a divider that takes inputs of the position signal and the magnetic-field signal in order to generate an origin signal that determines a reference position of the rotating body.

Other magnetic sensing devices have also been proposed that have a rotating body including a position signal generating part in which a plurality of continuous projections and indentations are provided with a predetermined pitch in the direction of the circumference of the rotating body for generating a position signal representing a position of the rotating body of the magnetic sensing device and an origin signal generating part which is integral with the position signal generating part and in which a protrusion having a length in the circumference direction that is equal to the pitch is formed for generating an origin signal that determines a reference position of the rotating body (For example, Japanese Unexamined Patent Publication No. JP-A-4-33511, Japanese Patent Publication No. JP-4085074, and Japanese Unexamined Patent Publication No. JP-A-2013-53990).

In this case, the sensor of the magnetic sensing devices includes a pair of magnetoresistive elements that detect a change in a magnetic field corresponding to a position signal and another pair of magnetoresistive elements that detect a change in a magnetic field corresponding to an origin signal.

Conventional magnetic sensing devices having a rotating body including the magnetic-field generating part in which a groove is formed needs to further include a subtracter or a divider, which may be an operational amplifier (op-amp), etc., in the circuit connected to the magnetic sensing device in order to generate an origin signal. This adds to the number of components, complexity of the configuration, and the footprint of the circuit connected to the magnetic sensing device. Furthermore, machining the groove to the length in the circumferential direction that is equal to the pitch requires a high degree of machining accuracy and accordingly a prolonged machining time. However, if the length of the groove in the circumferential direction is chosen to be greater than the pitch (for example twice the pitch) in order to enable formation of the groove without requiring a high degree of machining accuracy, the circuit connected to the magnetic sensing device would generate two or more origin signals, preventing accurate determination of a reference position of the rotating body.

On the other hand, conventional magnetic sensing devices having a rotating body including the origin signal generating part in which a protrusion is formed is unable to withstand fast rotation because the rotating body is limited to a sintered object and therefore has an insufficient strength. Furthermore, it has been difficult to fabricate a high-accuracy rotating body with a small pitch. If the protrusion is formed by machining in order to avoid the problem described above, the portion of the projections and indentations where the origin signal generating part is provided correspondingly to projections and indentations of the position signal generating part would need to be removed and therefore the machining time for forming the protrusion would be longer than the time for forming a groove.

Furthermore, the circuit connected to the magnetic sensing device having the rotating body including the magnetic-field signal generating part in which the groove is formed and the circuit connected to the magnetic sensing device having the rotating body including the origin signal generating part in which the protrusion is formed are not interchangeable with each other, which has impaired productivity, operability and serviceability.

An object of the present invention is to provide a magnetic sensing device that eliminates the need for providing a subtracter or a divider in a circuit to be connected to the magnetic sensing device to simplify the configuration of the circuit, has a rotating body that does not require a high degree of machining accuracy for machining the rotating unit to enable reduction of work time and machining time, and is able to withstand fast rotation and ensure interchangeability among circuits that are connected.

### SUMMARY OF THE INVENTION

A magnetic sensing device according to one embodiment of the present invention is a magnetic sensing device including a movable body made of a magnetic material and a sensor using magnetism to detect a position of the movable body. The movable body includes a position signal generating part in which a series of a plurality of continuous projections and indentations are provided with a predetermined pitch in a predetermined direction for generating a position signal representing a position of the movable body, and an origin signal generating part in which a discontinuous portion partly interrupting the continuity of the series of the plurality of projections and indentations provided with the predetermined pitch in the predetermined direction is provided for generating an origin signal that determines a reference position of the movable body. The sensor includes a first magnetoresistive element and a second magnetoresistive element spaced from each other in the predetermined direction with a distance equal to the predetermined pitch multiplied by ½ (2n−1) (n=1, 2, 3, . . . ) for detecting a change in a magnetic field that corresponds to the position signal, and a third magnetoresistive element and a fourth magnetoresistive element spaced from each other in the predetermined direction with a distance equal to the predetermined pitch multiplied by m (m=1, 2, 3, . . . ) for detecting a change in a magnetic field that corresponds to the origin signal.

Preferably, the discontinuous portion is formed by a groove, a hole, or a different member joined with the origin signal generating part.

### DESCRIPTION OF THE DRAWINGS

These and other features and advantages of the present invention will be better understood by reading the following detailed description, taken together with the drawings wherein:

FIG. 1 is a perspective view of a magnetic sensing device according to a first embodiment of the present invention;

FIG. 2A is a diagram illustrating a method for detecting a position by the magnetic sensing device according to the first embodiment of the present invention;

FIG. 2B is a diagram illustrating a method for detecting a position by the magnetic sensing device according to the first embodiment of the present invention;

FIG. 2C is a diagram illustrating a method for detecting a position by the magnetic sensing device according to the first embodiment of the present invention;

FIG. 3A is a diagram illustrating a method for detecting an origin signal generating part of a rotating body by the magnetic sensing device according to the first embodiment of the present invention;

FIG. 3B is a diagram illustrating the method for detecting the origin signal generating part of the rotating body by the magnetic sensing device according to the first embodiment of the present invention;

FIG. 3C is a diagram illustrating the method for detecting the origin signal generating part of the rotating body by the magnetic sensing device according to the first embodiment of the present invention;

FIG. 3D is a diagram illustrating the method for detecting the origin signal generating part of the rotating body by the magnetic sensing device according to the first embodiment of the present invention;

FIG. 3E is a diagram illustrating the method for detecting the origin signal generating part of the rotating body by the magnetic sensing device according to the first embodiment of the present invention;

FIG. 3F is a diagram illustrating the method for detecting the origin signal generating part of the rotating body by the magnetic sensing device according to the first embodiment of the present invention;

FIG. 4A is a diagram illustrating a method for detecting an origin signal generating part of a rotating body by a first variation of the magnetic sensing device according to the first embodiment of the present invention;

FIG. 4B is a diagram illustrating the method for detecting the origin signal generating part of the rotating body by the first variation of the magnetic sensing device according to the first embodiment of the present invention;

FIG. 4C is a diagram illustrating the method for detecting the origin signal generating part of the rotating body by the first variation of the magnetic sensing device according to the first embodiment of the present invention;

FIG. 5A is a diagram illustrating a method for detecting an origin signal generating part of a rotating body by a second variation of the magnetic sensing device according to the first embodiment of the present invention;

FIG. 5B is a diagram illustrating the method for detecting the origin signal generating part of the rotating body by the second variation of the magnetic sensing device according to the first embodiment of the present invention;

FIG. 5C is a diagram illustrating the method for detecting the origin signal generating part of the rotating body by the second variation of the magnetic sensing device according to the first embodiment of the present invention;

FIG. 5D is a diagram illustrating the method for detecting the origin signal generating part of the rotating body by the second variation of the magnetic sensing device according to the first embodiment of the present invention;

FIG. 5E is a diagram illustrating the method for detecting the origin signal generating part of the rotating body by the second variation of the magnetic sensing device according to the first embodiment of the present invention;

FIG. 6A is a diagram illustrating a method for detecting an origin signal generating part of a rotating body by a third variation of the magnetic sensing device according to the first embodiment of the present invention;

FIG. 6B is a diagram illustrating the method for detecting the origin signal generating part of the rotating body by the third variation of the magnetic sensing device according to the first embodiment of the present invention;

FIG. 6C is a diagram illustrating the method for detecting the origin signal generating part of the rotating body by the third variation of the magnetic sensing device according to the first embodiment of the present invention;

FIG. 6D is a diagram illustrating the method for detecting the origin signal generating part of the rotating body by the third variation of the magnetic sensing device according to the first embodiment of the present invention;

FIG. 6E is a diagram illustrating the method for detecting the origin signal generating part of the rotating body by the third variation of the magnetic sensing device according to the first embodiment of the present invention;

FIG. 6F is a diagram illustrating the method for detecting the origin signal generating part of the rotating body by the third variation of the magnetic sensing device according to the first embodiment of the present invention;

FIG. 6G is a diagram illustrating the method for detecting the origin signal generating part of the rotating body by the third variation of the magnetic sensing device according to the first embodiment of the present invention;

FIG. 7 is a perspective view of a magnetic sensing device according to a second embodiment of the present invention; and

FIG. 8 is a perspective view of a magnetic sensing device according to a third embodiment of the present invention.

### DETAILED DESCRIPTION OF THE PREFERRED EMBODIMENT

A magnetic sensing device according to a first embodiment of the present invention will be described with reference to drawings. Like elements are given like reference numerals throughout the drawings. For clarity, some of the elements in the drawings are not drawn to scale.

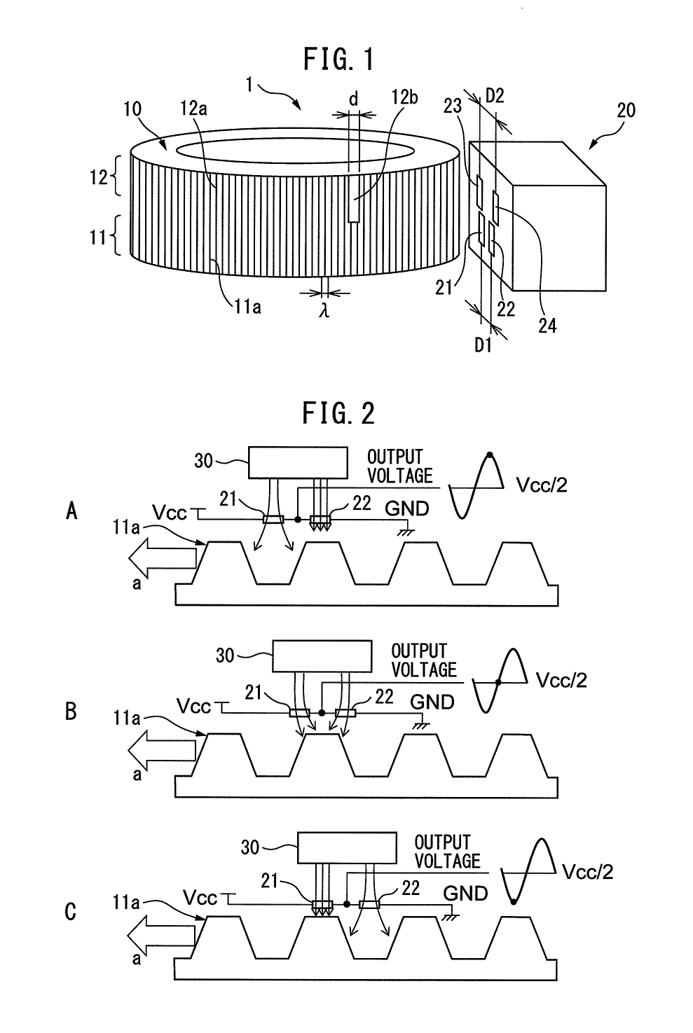

FIG. 1 is a perspective view of the magnetic sensing device according to the first embodiment of the present invention. The magnetic sensing device 1 in FIG. 1 includes an annular rotating body 10 as a movable body made of a magnetic material such as iron and a sensor 20 which uses magnetism to detect a position of the rotating body 10.

The rotating body 10 is designed to be attached to a rotating member (not depicted) such as an output shaft of a motor or a rotary shaft driven by a motor, and includes a position signal generating part 11 and an origin signal generating part 12 which is integral with the position signal generating part 11. A series of a plurality of continuous projections and indentations 11a are provided in the position signal generating part 11 with a predetermined pitch λ in the direction of the circumference of the rotating body 10, which is the predetermined direction, in order to generate a position signal representing a rotation angle as a position of the rotating body 10. The origin signal generating part 12 has a discontinuous portion 12b which partly interrupts the continuity of the series of the plurality of projections and indentations 12a provided with a pitch of λ in the direction of the circumference of the rotating body 10 in order to generate an origin signal that determines a reference position of the rotating body 10. The discontinuous portion 12b in this embodiment is formed of a groove and the length d of the discontinuous portion 12b in the direction of the circumference of the rotating body 10 is equal to λ.

The sensor 20 is disposed between the rotating body 10 and a magnet, not depicted in FIG. 1, and includes magnetoresistive elements 21, 22, 23, 24 whose resistances change according to the density of magnetic flux passing through them. The first magnetoresistive element 21 and the second magnetoresistive element 22 are spaced from each other with a distance D1 that is equal to the pitch λ multiplied by ½ (2n−1) (n=1, 2, 3, . . . ) in the direction of the circumference of the rotating body 10 in order to detect a change in a magnetic field that corresponds to a position signal. In this embodiment, D1 is equal to λ/2 (n=1). The third magnetoresistive element 23 and the fourth magnetoresistive element 24 are spaced from each other with a distance D2 that is equal to the pitch λ multiplied by m (m=1, 2, 3, . . . ) in the direction of the circumference of the rotating body 10 in order to detect a change in a magnetic field that corresponds to an origin signal. In this embodiment, D2 is equal to λ (m=1).

The length d is greater than the distance D2 or smaller than the distance D2 or equal to the distance D2 and can be decreased or increased within a range in which a proper origin signal can be obtained. The depth of the discontinuous portion 12b can be decreased or increased, or may continuously or stepwise change within a range in which a proper origin signal can be obtained. The bottom of the discontinuous portion 12b may be V-shaped or U-shaped to facilitate generation of a proper origin signal even if the discontinuous portion 12b is shallow. Additionally, the length d may be greater than or equal to 2λ so that the discontinuous portion 12b can be machined quickly with a machining accuracy lower than a machining accuracy required if the length d is equal to λ. In particular, the discontinuous portion 12b can be machined quickly with a high accuracy by machining using an indentation of the series of projections and indentations as a reference with an appropriate tool without using jigs or the like.

The first magnetoresistive element 21 and the second magnetoresistive element 22 are connected in series and a voltage Vcc is applied to the first magnetoresistive element 21 and the second magnetoresistive element 22 so that a position signal corresponding to a voltage between the first magnetoresistive element 21 and the second magnetoresistive element 22 is output to a circuit, not depicted, connected to the magnetic sensing device 1. The third magnetoresistive element 23 and the fourth magnetoresistive element 24 are connected in series, the voltage Vcc is applied to the third magnetoresistive element 23 and the fourth magnetoresistive element 24 so that an origin signal corresponding to a voltage between the third magnetoresistive element 23 and the fourth magnetoresistive element 24 is output to a circuit, not depicted, connected to the magnetic sensing device 1.

Generation of a position detection signal by the magnetic sensing device 1 will now be described. FIGS. 2A to 2C are diagrams illustrating a method for detecting a position by the magnetic sensing device according to the first embodiment of the present invention. When a first magnetoresistive element 21 and a second magnetoresistive element 22 face an indentation and a projection, respectively, of a projection and indentation part 11a while a rotating body 10 is rotating counterclockwise as indicated by arrow a (FIG. 2A), more magnetic flux from the magnet 30 passes through the second magnetoresistive element 22 and therefore the resistance of the second magnetoresistive element 22 is at its maximum whereas less magnetic flux passes through the first magnetoresistive element 21 and therefore the resistance of the first magnetoresistive element 21 is at its minimum. Accordingly, the output voltage, which is the voltage between the first magnetoresistive element 21 and the second magnetoresistive element 22, is at its maximum.

When the middle position between the first magnetoresistive element 21 and the second magnetoresistive element 22 coincides with the center of a projection of the projection and indentation part 11a while the rotating body 10 is rotating counterclockwise as indicated by arrow a (FIG. 2B), equal amounts of magnetic flux from the magnet 30 pass through the first magnetoresistive element 21 and the second magnetoresistive element 22 and therefore the resistance of the first magnetoresistive element 21 is equal to the resistance of the second magnetoresistive element 22. Accordingly, the output voltage, which is the voltage between the first magnetoresistive element 21 and the second magnetoresistive element 22, is Vcc/2.

When the first magnetoresistive element 21 and the second magnetoresistive element 22 face a projection and an indentation, respectively, of the projection and indentation part 11a while the rotating body 10 is rotating counterclockwise as indicated by arrow a (FIG. 2C), more magnetic flux from the magnet 30 passes through the first magnetoresistive element 21 and therefore the resistance of the first magnetoresistive element 21 is at its maximum whereas less magnetic flux passes through the second magnetoresistive element 22 and therefore the resistance of the second magnetoresistive element 22 is at its minimum. Accordingly, the output voltage, which is the voltage between the first magnetoresistive element 21 and the second magnetoresistive element 22, is at its minimum.

Thus, the output voltage is an output signal with a sine wave that follows the motion of the rotating body 10. The circuit connected to the magnetic sensing device 1 processes the output signal to detect a rotational position of the rotating body 10, i.e., a rotation angle of the rotating member, not depicted, to which the rotating body 10 is attached.

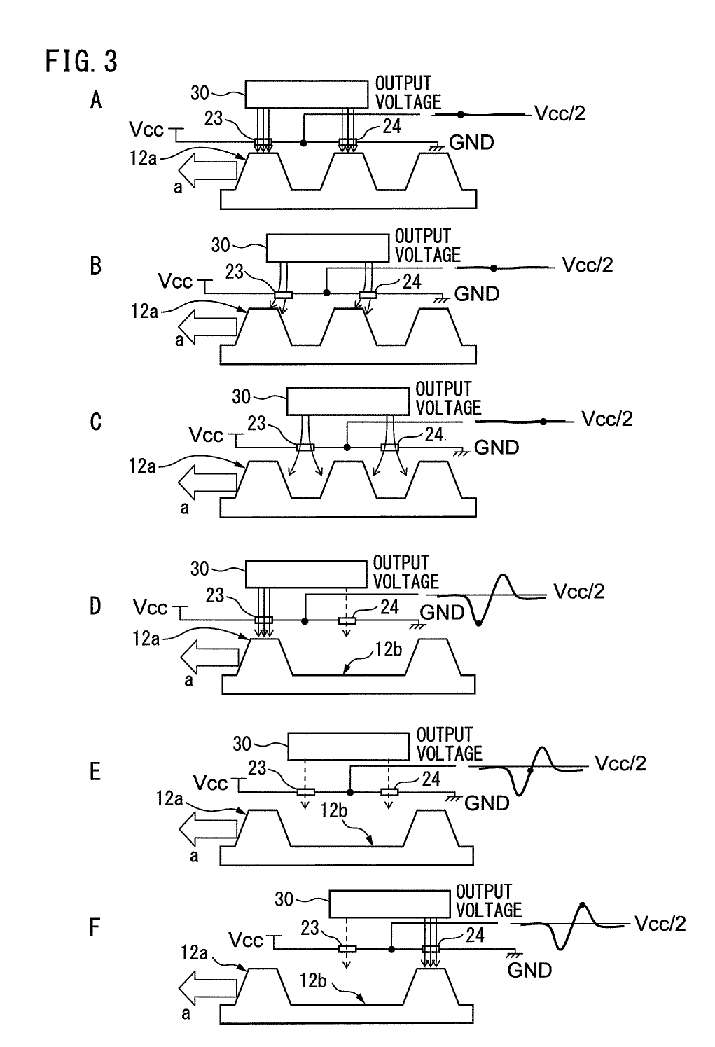

Generation of an origin detection signal by the magnetic sensing device 1 will be described next. FIGS. 3A to 3F are diagrams illustrating a method for detecting the origin signal generating part of the rotating body by the magnetic sensing device according to the first embodiment of the present invention. When a third magnetoresistive element 23 faces a projection of a projection and indentation part 12a and a fourth magnetoresistive element 24 faces the next projection of the projection and indentation part 12a while the rotating body 10 is rotating counterclockwise as indicated by arrow a (FIG. 3A), equal amounts of magnetic flux from a magnet 30 pass through the third magnetoresistive element 23 and the fourth magnetoresistive element 24 and therefore the resistance of the third magnetoresistive element 23 is equal to the resistance of the fourth magnetoresistive element 24. Accordingly, the output voltage, which is the voltage between the third magnetoresistive element 23 and the fourth magnetoresistive element 24 is Vcc/2.

When the third magnetoresistive element 23 faces the surface between a projection and an indentation of the projection and indentation part 12a and the fourth magnetoresistive element 24 faces the surface between the next projection and indentation of the projection and indentation part 12a while the rotating body 10 is rotating counterclockwise as indicated by arrow a (FIG. 3B), equal amounts of magnetic flux from the magnet 30 pass through the third magnetoresistive element 23 and the fourth magnetoresistive element 24 and therefore the resistance of the third magnetoresistive element 23 is equal to the resistance of the fourth magnetoresistive element 24. Accordingly, the output voltage, which is the voltage between the third magnetoresistive element 23 and the fourth magnetoresistive element 24, is Vcc/2.

When the third magnetoresistive element 23 faces an indentation of the projection and indentation part 12a and the fourth magnetoresistive element 24 faces the next indentation while the rotating body 10 is rotating counterclockwise as indicated by arrow a (FIG. 3C), equal amounts of magnetic flux from the magnet 30 pass through the third magnetoresistive element 23 and the fourth magnetoresistive element 24, and therefore the resistance of the third magnetoresistive element 23 is equal to the resistance of the fourth magnetoresistive element 24. Accordingly, the output voltage, which is the voltage between the third magnetoresistive element 23 and the fourth magnetoresistive element 24, is Vcc/2.

In this way, when the third magnetoresistive element 23 and the fourth magnetoresistive element 24 face the projection and indentation part 12a, equal amounts of magnetic flux from the magnet 30 pass through the third magnetoresistive element 23 and the fourth magnetoresistive element 24 and therefore the output voltage, which is the voltage between the third magnetoresistive element 23 and the fourth magnetoresistive element 24, does not change from Vcc/2.

When the third magnetoresistive element 23 faces a projection of the projection and indentation part 12a and the fourth magnetoresistive element 24 faces a discontinuous portion 12b while the rotating body 10 is rotating counterclockwise as indicated by arrow a (FIG. 3D), more magnetic flux from the magnet 30 passes through the third magnetoresistive element 23 and therefore the resistance of the third magnetoresistive element 23 is at its maximum whereas less magnetic flux passes through the fourth magnetoresistive element 24 and therefore the resistance of the fourth magnetoresistive element 24 is at its minimum. Accordingly, the output voltage, which is the voltage between the third magnetoresistive element 23 and the fourth magnetoresistive element 24, is at its minimum.

When the third magnetoresistive element 23 and the fourth magnetoresistive element 24 face the discontinuous portion 12b while the rotating body 10 is rotating counterclockwise as indicted by arrow a (FIG. 3E), equal amounts of magnetic flux from the magnet 30 pass through the third magnetoresistive element 23 and the fourth magnetoresistive element 24 and therefore the resistance of the third magnetoresistive element 23 is equal to the resistance of the fourth magnetoresistive element 24. Accordingly, the output voltage, which is the voltage between the third magnetoresistive element 23 and the fourth magnetoresistive element 24, is Vcc/2.

When the third magnetoresistive element 23 faces the discontinuous portion 12b and the fourth magnetoresistive element 24 faces a projection of the projection and indentation part 12a while the rotating body 10 is rotating counterclockwise as indicated by arrow a (FIG. 3F), more magnetic flux from the magnet 30 passes through the fourth magnetoresistive element 24 and therefore the resistance of the fourth magnetoresistive element 24 is at its maximum whereas less magnetic flux passes through the third magnetoresistive element 23 and therefore the resistance of the third magnetoresistive element 23 is at its minimum. Accordingly, the output voltage, which is the voltage between the third magnetoresistive element 23 and the fourth magnetoresistive element 24, is at its maximum.

Thus, the output voltage when the third magnetoresistive element 23 and the fourth magnetoresistive element 24 face the discontinuous portion 12b is an output signal with a sine wave that follows the motion of the rotating body 10. The circuit connected to the magnetic sensing device 1 processes the output signal to determine a reference position of the rotating body 10, i.e., a reference position of the rotating member, not depicted, to which the rotating body 10 is attached.

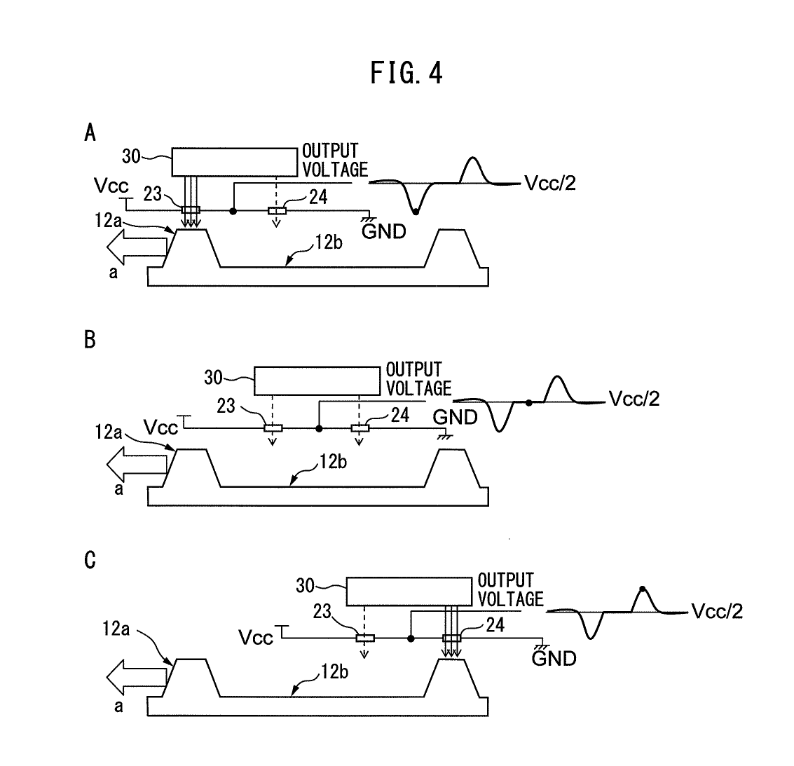

FIGS. 4A to 4C are diagrams illustrating a method for detecting an origin signal generating part of a rotating body by a first variation of the magnetic sensing device according to the first embodiment of the present invention. With reference to FIGS. 4A to 4C, output voltages when at least one of a third magnetoresistive element 23 and a fourth magnetoresistive element 24 faces a discontinuous portion 12b will be described, where the distance d is equal to 2λ and the distance D2 is equal to λ.

When the third magnetoresistive element 23 faces a projection of a projection and indentation part 12a and the fourth magnetoresistive element 24 faces the discontinuous portion 12b while the rotating body 10 is rotating counterclockwise as indicated by arrow a (FIG. 4A), more magnetic flux from a magnet 30 passes through the third magnetoresistive element 23 and therefore the resistance of the third magnetoresistive element 23 is at its maximum whereas less magnetic flux passes through the fourth magnetoresistive element 24 and therefore the resistance of the fourth magnetoresistive element 24 is at its minimum. Accordingly, the output voltage, which is the voltage between the third magnetoresistive element 23 and the fourth magnetoresistive element 24, is at its minimum.

When the third magnetoresistive element 23 and the fourth magnetoresistive element 24 face the discontinuous portion 12b while the rotating body 10 is rotating counterclockwise as indicated by arrow a (FIG. 4B), equal amounts of magnetic flux from the magnet 30 pass through the third magnetoresistive element 23 and the fourth magnetoresistive element 24 and therefore the resistance of the third magnetoresistive element 23 is equal to the resistance of the fourth magnetoresistive element 24. Accordingly, the output voltage, which is the voltage between the third magnetoresistive element 23 and the fourth magnetoresistive element 24, is Vcc/2.

When the third magnetoresistive element 23 faces the discontinuous portion 12b and the fourth magnetoresistive element 24 faces a projection of the projection and indentation part 12a while the rotating body 10 is rotating counterclockwise as indicated by arrow a (FIG. 4C), more magnetic flux from the magnet 30 passes through the fourth magnetoresistive element 24 and therefore the resistance of the fourth magnetoresistive element 24 is at its maximum whereas the less magnetic flux passes through the third magnetoresistive element 23 and therefore the resistance of the third magnetoresistive element 23 is at its minimum. Accordingly, the output voltage, which is the voltage between the third magnetoresistive element 23 and the fourth magnetoresistive element 24, is at its maximum.

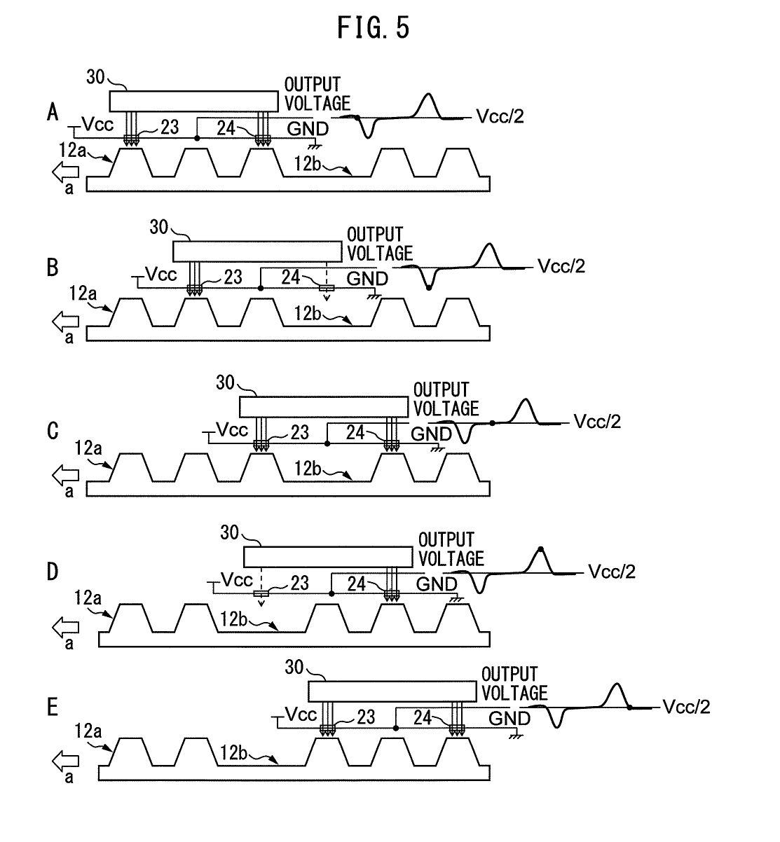

FIGS. 5A to 5E are diagrams illustrating a method for detecting an origin signal generating part by a second variation of the magnetic sensing device according to the first embodiment of the present invention. With reference to FIGS. 5A to 5E, output voltages in an example where the distance d is equal to λ and the distance D2 is equal to 2λ will be described. When a third magnetoresistive element 23 faces a projection of a projection and indentation part 12a and a fourth magnetoresistive element 24 faces the next but one projection while a rotating body 10 is rotating counterclockwise as indicated by arrow a (FIG. 5A), equal amounts of magnetic flux from a magnet 30 pass through the third magnetoresistive element 23 and the fourth magnetoresistive element 24 and therefore the resistance of the third magnetoresistive element 23 is equal to the resistance of the fourth magnetoresistive element 24. Accordingly, the output voltage, which is the voltage between the third magnetoresistive element 23 and the fourth magnetoresistive element 24, is Vcc/2.

When the third magnetoresistive element 23 faces a projection of the projection and indentation part 12a and the fourth magnetoresistive element 24 faces a discontinuous portion 12b while the rotating body 10 is rotating counterclockwise as indicated by arrow a (FIG. 5B), more magnetic flux from the magnet 30 passes through the third magnetoresistive element 23 and therefore the resistance of the third magnetoresistive element 23 is at its maximum whereas less magnetic flux passes through the fourth magnetoresistive element 24 and therefore the resistance of the fourth magnetoresistive element 24 is at its minimum. Accordingly, the output voltage, which is the voltage between the third magnetoresistive element 23 and the fourth magnetoresistive element 24, is at its minimum.

When the third magnetoresistive element 23 faces a projection (one of the projections adjacent to the discontinuous portion 12b) of the projection and indentation part 12a and the fourth magnetoresistive element 24 faces a projection (the other of the projections adjacent to the discontinuous portion 12b) of the projection and indentation part 12a while the rotating body 10 is rotating counterclockwise as indicated by arrow a (FIG. 5C), equal amounts of magnetic flux from the magnet 30 pass through the third magnetoresistive element 23 and the fourth magnetoresistive element 24 and therefore the resistance of the third magnetoresistive element 23 is equal to the resistance of the fourth magnetoresistive element 24. Accordingly, the output voltage, which is the voltage between the third magnetoresistive element 23 and the fourth magnetoresistive element 24, is Vcc/2.

When the third magnetoresistive element 23 faces the discontinuous portion 12b and the fourth magnetoresistive element 24 faces a projection of the projection and indentation part 12a while the rotating body 10 is rotating counterclockwise as indicated by arrow a (FIG. 5D), more magnetic flux from the magnet 30 passes through the fourth magnetoresistive element 24, and therefore the resistance of the fourth magnetoresistive element 24 is at its maximum whereas less magnetic flux passes through the third magnetoresistive element 23 and therefore the resistance of the third magnetoresistive element 23 is at its minimum. Accordingly, the output voltage, which is the voltage between the third magnetoresistive element 23 and the fourth magnetoresistive element 24, is at its maximum.

When the third magnetoresistive element 23 faces a projection (adjacent to the discontinuous portion 12b) of the projection and indentation part 12a and the fourth magnetoresistive element 24 faces a projection of the projection and indentation part 12a while the rotating body 10 is rotating counterclockwise as indicated by arrow a (FIG. 5E), equal amounts of magnetic flux from the magnet 30 pass through the third magnetoresistive element 23 and the fourth magnetoresistive element 24, and therefore the resistance of the third magnetoresistive element 23 is equal to the resistance of the fourth magnetoresistive element 24. Accordingly, the output voltage, which is the voltage between the third magnetoresistive element 23 and the fourth magnetoresistive element 24, is Vcc/2.

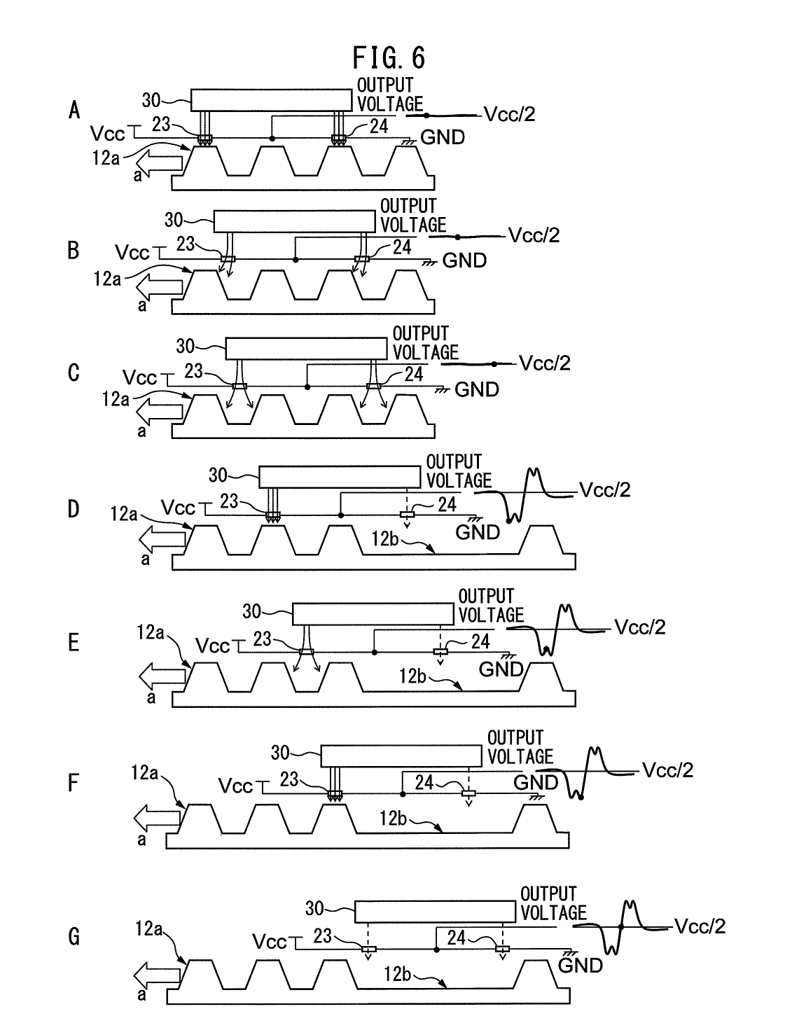

FIGS. 6A to 6G are diagrams illustrating a method for detecting an origin by a third variation of the magnetic sensing device according to the first embodiment of the present invention. With reference to FIGS. 6A to 6G, output voltages in an example where both of the distances d and D2 are equal to 2λ will be described. When a third magnetoresistive element 23 faces a projection of a projection and indentation part 12a and a fourth magnetoresistive element 24 faces the next but one projection while a rotating body 10 is rotating counterclockwise as indicated by arrow a (FIG. 6A), equal amounts of magnetic flux from a magnet 30 pass through the third magnetoresistive element 23 and the fourth magnetoresistive element 24 and therefore the resistance of the third magnetoresistive element 23 is equal to the resistance of the fourth magnetoresistive element 24. Accordingly, the output voltage, which is the voltage between the third magnetoresistive element 23 and the fourth magnetoresistive element 24, is Vcc/2.

When the third magnetoresistive element 23 faces the surface between a projection and an indentation of the projection and indentation part 12a and the fourth magnetoresistive element 24 faces the surface between the next but one projection and indentation while the rotating body 10 is rotating counterclockwise as indicated by arrow a (FIG. 6B), equal amounts of magnetic flux from the magnet 30 pass through the third magnetoresistive element 23 and the fourth magnetoresistive element 24 and therefore the resistance of the third magnetoresistive element 23 is equal to the resistance of the fourth magnetoresistive element 24. Accordingly, the output voltage, which is the voltage between the third magnetoresistive element 23 and the fourth magnetoresistive element 24, is Vcc/2.

When the third magnetoresistive element 23 faces an indentation of the projection and indentation part 12a and the fourth magnetoresistive element 24 faces the next but one indentation while the rotating body 10 is rotating counterclockwise as indicated by arrow a (FIG. 6C), equal amounts of magnetic flux from the magnet 30 pass through the third magnetoresistive element 23 and the fourth magnetoresistive element 24, and therefore the resistance of the third magnetoresistive element 23 is equal to the resistance of the fourth magnetoresistive element 24. Accordingly, the output voltage, which is the voltage between the third magnetoresistive element 23 and the fourth magnetoresistive element 24, is Vcc/2.

In this way, when the third magnetoresistive element 23 and the fourth magnetoresistive element 24 face the projection and indentation part 12a, equal amounts of magnetic flux from the magnet 30 pass through the third magnetoresistive element 23 and the fourth magnetoresistive element 24 and therefore the output voltage, which is the voltage between the third magnetoresistive element 23 and the fourth magnetoresistive element 24, does not change from Vcc/2.

When the third magnetoresistive element 23 faces a projection of the projection and indentation part 12a and the fourth magnetoresistive element 24 faces a discontinuous portion 12b while the rotating body 10 is rotating counterclockwise as indicated by arrow a (FIG. 6D), more magnetic flux from the magnet 30 passes through the third magnetoresistive element 23 and therefore the resistance of the third magnetoresistive element 23 is at its maximum whereas less magnetic flux passes through the fourth magnetoresistive element 24 and therefore the resistance of the fourth magnetoresistive element 24 is at its minimum. Accordingly, the output voltage, which is the voltage between the third magnetoresistive element 23 and the fourth magnetoresistive element 24, is at its minimum.

When the third magnetoresistive element 23 faces an indentation of the projection and indentation part 12a and the fourth magnetoresistive element 24 faces the discontinuous portion 12b while the rotating body 10 is rotating counterclockwise as indicated by arrow a (FIG. 6E), the amount of magnetic flux from the magnet 30 that passes through the third magnetoresistive element 23 decreases and therefore the resistance of the third magnetoresistive element 23 decreases. Accordingly, the output voltage, which is the voltage between the third magnetoresistive element 23 and the fourth magnetoresistive element 24, is greater than its minimum and smaller than Vcc/2.

When the third magnetoresistive element 23 faces a projection (adjacent to the discontinuous portion 12b) of the projection and indentation part 12a and the fourth magnetoresistive element 24 faces the discontinuous portion 12b while the rotating body 10 is rotating counterclockwise as indicated by arrow a (FIG. 6F), more magnetic flux from the magnet 30 passes through the third magnetoresistive element 23, and therefore the resistance of the third magnetoresistive element 23 is at its maximum whereas less magnetic flux passes through the fourth magnetoresistive element 24 and therefore the resistance of the fourth magnetoresistive element 24 is at its minimum. Accordingly, the output voltage, which is the voltage between the third magnetoresistive element 23 and the fourth magnetoresistive element 24, is at its minimum.

When the third magnetoresistive element 23 and the fourth magnetoresistive element 24 face the discontinuous portion 12b while the rotating body 10 is rotating counterclockwise as indicated by arrow a (FIG. 6G), equal amounts of magnetic flux from the magnet 30 pass through the third magnetoresistive element 23 and the fourth magnetoresistive element 24, and therefore the resistance of the third magnetoresistive element 23 is equal to the resistance of the fourth magnetoresistive element 24. Accordingly, the output voltage, which is the voltage between the third magnetoresistive element 23 and the fourth magnetoresistive element 24, is Vcc/2.

When the third magnetoresistive element 23 and the fourth magnetoresistive element 24, both of which have faced the discontinuous portion 12b, come to face the projection and indentation part 12a while the rotating body 10 is rotating counterclockwise as indicated by arrow a, the output voltage increases from Vcc/2 to its maximum, then decreases to a value greater than Vcc/2 and smaller than its maximum, then increases from the value greater than Vcc/2 and smaller than its maximum to its maximum, and then decreases to Vcc/2.

In this way, the output voltage when the third magnetoresistive element 23 and the fourth magnetoresistive element 24 face the discontinuous portion 12b is an output signal having a waveform close to a sine wave that follows the motion of the rotating body 10. The circuit connected to the magnetic sensing device 1 processes the output signal to determine a reference position of the rotating body 10, i.e., a reference position of the rotating member, not depicted, to which the rotating body 10 is attached.

According to the embodiment, since the third magnetoresistive element 23 and the fourth magnetoresistive element 24 can directly generate an origin position signal, the circuit connected to the magnetic sensing device 1 does not need a subtracter or a divider for generating an origin position signal. Accordingly, the configuration of the circuit connected to the magnetic sensing device 1 can be simplified.

Furthermore, since the length d of the discontinuous portion 12b can be chosen to be greater than λ, the discontinuous portion 12b can be easier to machine than the case of forming a groove having a length equal to λ. Moreover, since formation of the discontinuous portion 12b does not need removal of a large part of the projection and indentation part 12a, machining time is reduced as compared with the case where the projection and indentation part 12a is removed except one indentation.

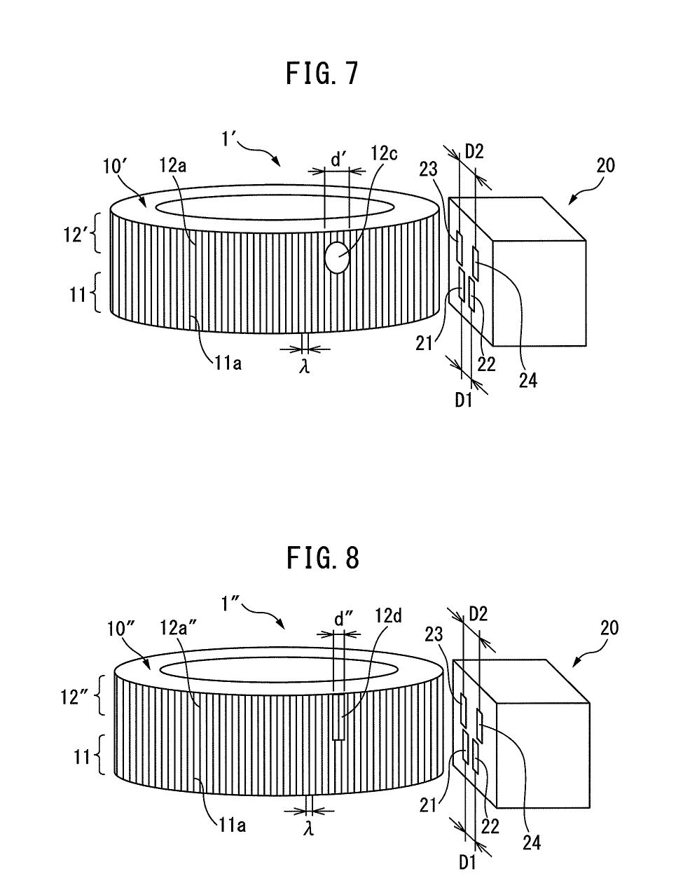

FIG. 7 is a perspective view of a magnetic sensing device according to a second embodiment of the present invention. A discontinuous portion 12c formed of a hole is provided in an origin signal generating part 12′ of a rotating body 10′ of a magnetic sensing device 1′ in FIG. 7. In this embodiment, the length d′ of the discontinuous portion 12c in the direction of the circumference of the rotating body 10′ is equal to 3λ and the distance D2 is equal to 3λ. The output voltage when a third magnetoresistive element 23 and a fourth magnetoresistive element 24 face the discontinuous portion 12c is an output signal having a waveform close to a sine wave that follows the motion of the rotating body 10 as illustrated in FIGS. 4A to 4C.

FIG. 8 is a perspective view of a magnetic sensing device according to a third embodiment of the present invention. In FIG. 8, a discontinuous portion 12d formed of a different member joined with an origin signal generating part 12″ of a rotating body 10″ of a magnetic sensing device 1″ is provided in the discontinuous portion 12d. The length d″ of the discontinuous portion 12d in the direction of the circumference of the rotating body 10″ is equal to λ and the distance D2 is equal to λ. The output voltage when a third magnetoresistive element 23 and a fourth magnetoresistive element 24 face the discontinuous portion 12d is an output signal with a sine wave that follows the motion of the rotating body 10 as illustrated in FIGS. 3A to 3F.

The present invention is not limited to the embodiments described above; many modifications and variations are possible. For example, the present invention is also applicable to a liner position detector that has a linear movable body. Furthermore, a discontinuous portion may be formed of a member other than a groove, a hole, or a different member joined with the origin signal generating part. Additionally, m and n may be integers greater than or equal to 1.

According to the present invention, the configuration of a circuit to be connected to the magnetic sensing device is simplified, machining is facilitated, machining time is reduced, fast rotation is enabled, and interchangeability among circuits to be connected to the magnetic sensing device can be ensured.

What is claimed is:

1. A magnetic sensing device including a movable body made of a magnetic material and a sensor using magnetism to detect a position of the movable body,
the movable body comprising:
a position signal generating part in which a series of a plurality of continuous projections and indentations are provided with a predetermined pitch in a predetermined direction for generating a position signal representing a position of the movable body; and
an origin signal generating part in which a discontinuous portion partly interrupting the continuity of the series of the plurality of projections and indentations provided with the predetermined pitch in the predetermined direction is provided for generating an origin signal that determines a reference position of the movable body;
the sensor comprising:
a first magnetoresistive element and a second magnetoresistive element spaced from each other in the predetermined direction with a distance equal to the predetermined pitch multiplied by ½ (2n−1) for detecting a change in a magnetic field, the change corresponding to the position signal, where n=1, 2, 3, . . . ; and
a third magnetoresistive element and a fourth magnetoresistive element spaced from each other in the predetermined direction with a distance equal to the predetermined pitch multiplied by m for detecting a change in a magnetic field, the change corresponding to the origin signal, where m=1, 2, 3, . . . .

2. The magnetic sensing device according to claim 1, wherein the discontinuous portion is formed by a groove, a hole, or a different member joined with the origin signal generating part.
